(19) United States
(12) Patent Application Publication
(10) Pub. No.: US 2010/0328006 A1
(43) Pub. Date: Dec. 30, 2010

(54) POWER TRANSFER DEVICE

(75) Inventor: Etienne Nicolaas Kathalijntje Paulus Marie Eberson, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/809,085

(22) PCT Filed: Dec. 26, 2008
(86) PCT No.: PCT/IB2008/055542

§ 371 Date: Aug. 30, 2010

(30) Foreign Application Priority Data
Dec. 29, 2007 (CN) 200710308136.9

(51) Int. Cl. H01F 30/06

(52) U.S. Cl. 336/170

(57) ABSTRACT

This invention relates to a power transfer device via electromagnetic interaction. this invention proposes a power transfer device, comprising: a primary coil for transferring a power, including a first primary coil and a second primary coil; a secondary coil for transferring the power with the primary coil via electromagnetic interaction; wherein the secondary coil is positioned between the first primary coil and the second primary coil, the first and the second primary coil being configured to render the directions of the magnet fields they induce across the secondary coil consistent. With the specific association and positioning of the primary coil and the secondary coil, the power can be transferred between the primary coil and the secondary coil effectively; therefore, the size of the transfer device can be reduced significantly. This invention can be used for charging device, e.g. components of lighting products, electrical charging device, etc.

### FIELD OF THE INVENTION

This invention relates to a power transfer device via electromagnetic interaction.

### BACKGROUND OF THE INVENTION

FIG. 1 shows a transformer of the prior art. This inductive coupled topology transfers power from the primary 101 to the secondary 102 side without electric contact. The absence of an electric contact between the primary 101 and the secondary 102 side allows the use of completely separate systems that can be used in air or even water. This has the additional advantage that the wires and connections of the transformer will no longer be damaged or corroded by aggressive or hazardous environments.

Based on the mechanical diameter, the largest component of the transformer is the primary coil. The compactness of the total system thus depends on the size of the primary coil, and its minimum size depends on the amount of inductance needed by the primary side. As technology develops, the demand for compact devices increases, so that it is also desirable to reduce the size of the power transfer device.

### OBJECT AND SUMMARY OF THE INVENTION

It is an object of the invention to provide a power transfer device, which has compact size and high power transfer performance.

To this end, this invention proposes a power transfer device, comprising: a primary coil for transferring a power, including a first primary coil and a second primary coil; a secondary coil for transferring the power with the primary coil via electromagnetic interaction; wherein the secondary coil is positioned between the first primary coil and the second primary coil, the first and the second primary coil being configured to render the directions of the magnet fields they induce across the secondary coil consistent.

Optionally, the first and the second primary coil and the secondary coil are arranged concentrically.

Optionally, the first and the second primary coil and the secondary coil are annular.

Optionally, the number of coil layers in the first and the second primary coil is no more than six.

Optionally, the number of coil layers in the first and the second primary coil is three.

This invention also proposes a device for transferring a power, comprising a first primary coil and a second primary coil, said device being configured to transferring a power with a secondary coil, said secondary coil being positioned in between the first and the second coil, said first and second primary coil being configured to render the directions of the magnet fields they induce across the secondary coil consistent.

Optionally, the first and the second primary coil and the secondary coil are annular and arranged concentrically.

This invention also proposes a device for transferring a power, said device comprising a secondary coil, said secondary coil being configured to transfer the power with a first primary coil and a second primary coil, said secondary coil being positioned in between the first and the second primary coil, said first and second primary coil being configured to render the directions of the magnet fields they induce across the secondary coil consistent.

Optionally, the first and the second primary coil and the secondary coil are annular and arranged concentrically.

With the specific association and positioning of the primary coil and the secondary coil, the power can be transferred between the primary coil and the secondary coil effectively; therefore, the size of the transfer device can be reduced significantly.

These and other aspects of the invention will be apparent from the description of the present invention with reference to the following figures and claims, to allow one to have a thorough understanding of the present invention.

### BRIEF DESCRIPTION OF THE DRAWINGS

The present invention will now be explained, by way of example only, with reference to the accompanying figures, where:

FIG. 1 schematically shows a transformer of the prior art, wherein FIG. 1A is a cross-section and FIG. 1B is a top view of the primary and the secondary coil.

FIG. 2 schematically shows a power transfer device according to the invention, wherein

FIG. 2A is a cross-sectional view and FIG. 2B is a top view of the power transfer device.

FIG. 3 schematically shows the distribution of magnet fields between the primary and the secondary coil.

FIG. 4 schematically shows a device comprising a first primary coil and a second primary coil for transferring power with a secondary coil according to the invention, wherein FIG. 4A is a top view of the device and FIG. 4B is the cross-sectional

FIG. 5 schematically shows a device comprising a secondary coil for transferring power with a primary coil according to the invention.

In the above drawings, the same reference symbol indicates the same, similar or corresponding characteristics or functions.

### DESCRIPTION OF EMBODIMENTS

The power transfer device according to the invention will be elucidated by way of example below by taking a lighting application as an instance. This lighting system uses a transformer approach to couple power from the primary to the secondary coil without electrical contact. A current application of this lighting system is its use in the field of air ducts, while future extensions of this application to wider ranges are feasible.

Based on the mechanical diameter, the largest component of the transformer is the primary coil, and its minimum size depends on the amount of inductance needed by the primary side. The amount of inductance of the primary coil can be increased by raising the number of coil layers. If there are a fixed number of coil layers, the inductance can also be increased by raising the height of the coil. Increasing the amount of inductance by raising the height of the coil may cause the complete system to become higher. When the height of the power transfer system is limited to the building height of its electronic components, the coil needs to be designed in such a way that it has a higher inductance rather than an increased height.

Table 1 illustrates by way of example that, when the required inductance is 600 μH, the calculations of the type of wire and the number of layers show the following results:

TABLE 1

| | | | Grade 3 | Grade 3 | | | | | | | |
|---|---|---|---|---|---|---|---|---|---|---|---|
| | | | Diameter | Diameter | | | | | | | |
| Nom. | | | Copper | wire incl. | Primary coil | | | | | | |
| strand | | | only | isolation | turns | | Thickness primary | | | | |
| diameter | # | nom | max. | max. | per | # | coil package | Length wire | DC resistance | | Winding losses |
| (mm) | Strands | (l/m) | (mm) | (mm) | layer | layers | (mm) | (m) | (Ohm) | Factor Fr | (Watt) |
| 0.040 | 7 | 1.9821 | 0.195 | 0.235 | 37 | 3 | 0.80 | 15.7 | 31.1 | 1.06 | 22.1 |
| 0.040 | 8 | 1.7344 | 0.209 | 0.249 | 35 | 3 | 0.84 | 15.7 | 27.2 | 1.07 | 19.5 |
| 0.040 | 10 | 1.3875 | 0.233 | 0.273 | 32 | 3 | 0.91 | 15.7 | 21.7 | 1.09 | 15.9 |
| 0.040 | 12 | 1.1563 | 0.255 | 0.295 | 30 | 3 | 0.98 | 15.7 | 18.1 | 1.11 | 13.5 |
| 0.040 | 15 | 0.9250 | 0.288 | 0.328 | 27 | 3 | 1.07 | 15.7 | 14.5 | 1.15 | 11.2 |
| 0.040 | 20 | 0.6938 | 0.335 | 0.375 | 23 | 4 | 1.62 | 16.0 | 11.1 | 1.11 | 8.3 |
| 0.040 | 25 | 0.5550 | 0.378 | 0.418 | 21 | 4 | 1.79 | 16.0 | 8.9 | 1.15 | 6.8 |
| 0.040 | 30 | 0.4625 | 0.414 | 0.454 | 19 | 5 | 2.42 | 16.3 | 7.5 | 1.11 | 5.6 |
| 0.040 | 35 | 0.3964 | 0.447 | 0.487 | 18 | 5 | 2.58 | 16.3 | 6.5 | 1.14 | 4.9 |
| 0.040 | 45 | 0.3083 | 0.507 | 0.547 | 16 | 5 | 2.88 | 16.3 | 5.0 | 1.18 | 4.0 |
| 0.040 | 60 | 0.2313 | 0.585 | 0.625 | 14 | 6 | 3.93 | 16.5 | 3.8 | 1.17 | 3.0 |

It can be seen from Table 1 that, when considering the winding losses (last column), the most optimum design with regard to these losses is the design having six layers (last row). However, when the number of the stacked coil layers increases, the power transfer performance does not further improve. Empirical tests have shown that the best power transfer performance is realized with a number of three stacked coil layers. The Table shows that six layers of primary coil will not provide the best power transfer to the secondary coil. According to the data provided in Table 1, the system will have 11.2 Watt losses when three primary coil layers are used, whereas six primary coil layers will have only 3 Watt losses when the optimum solution that takes these losses into consideration is used.

The following Table illustrates the power losses in the primary coil as a function of the height.

TABLE 2

| Height | Minimum power loss |
|---|---|
| (mm) | with 3 layers (W) |
| 10 | 11.2 |
| 12 | 8.5 |
| 14 | 6.2 |
| 16 | 5.5 |
| 18 | 4.7 |
| 20 | 4.0 |
| 25 | 3.4 |
| 28 | 3.3 |

As can be seen, an increase of the height of three layers of the primary coil from 9.2 mm to 28 mm cannot even match the small amount of losses (3W) of the six-layer option. There is a need to achieve a balance between improvement of the power transfer performance and reduction of the loss of power.

Therefore, one embodiment of the invention provides a power transfer device as shown in FIG. 2. The primary coil is divided into two, namely the first primary coil 201 and the second primary coil 202. The secondary coil 203 is positioned in between the first primary coil 201 and the second primary coil 202. FIG. 2a is a cross-sectional view and FIG. 2b is a top view of the power transfer device according to one embodiment of the invention. It can be seen from FIG. 2 that the first 201 and the second primary coil 202 are arranged on respective opposite sides of the secondary coil 203.

To achieve a better power transfer performance, the number of coil layers of the first 201 and the second primary coil 202 is preferably no more than six, e.g. three. Alternatively, the number of layers of the first and the second primary coil may be different.

According to one embodiment of the invention, the first and the second primary coil and the secondary coil may be annular and are arranged concentrically on opposite sides of the secondary coil.

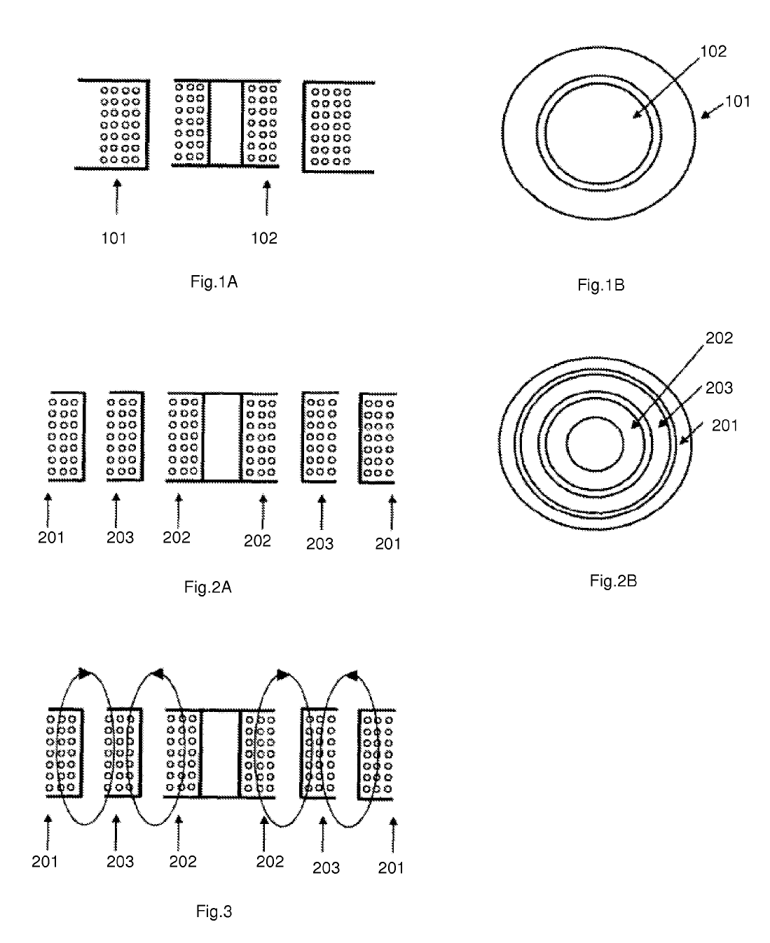

FIG. 3 schematically shows the distribution of fields between the primary and the secondary coil, wherein the first 201 and the second primary coil 202 are configured to render the directions of the fields they induce across the secondary coil 203 consistent. Splitting the primary coil in two can reduce the power dissipation substantially and keep the without adding the size of the coils. According to the invention, the primary coil has an inductance which is 80% higher than that of the conventional primary coil shown in FIG. 1, but without a change of size. In this way, the power can be effectively transferred from the primary coil to the secondary coil. On the other hand, it is understandable to the skilled person in the field that the power can also be transferred to the primary coil in the different examples.

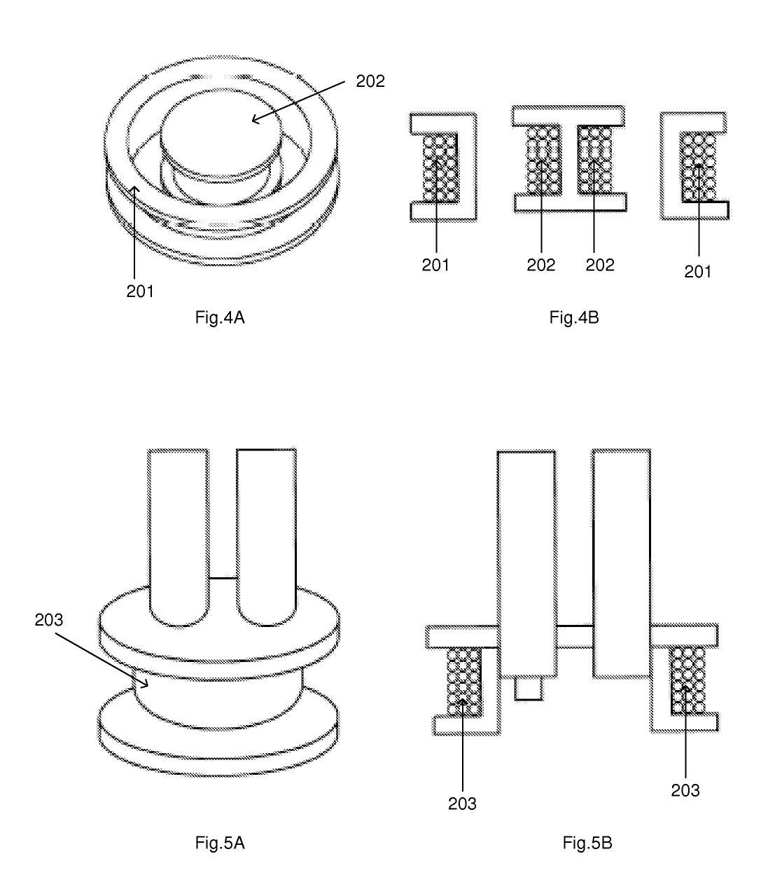

FIG. 4 schematically shows a device comprising a first primary coil 201 and a second primary coil 202 for transferring power with a secondary coil 203 according to the invention, wherein FIG. 4A is a top view of the device and FIG. 4B is the cross-sectional view of the device.

FIG. 5 schematically shows a device comprising a secondary 203 coil for transferring power with a first primary coil 201 and a second primary coil 202 according to the invention.

According to the mechanism already described, the device shown in FIG. 4 can be a first device for associating to a second device as shown in FIG. 5 and transferring the power to the second device, vice versa.

Application of the power transfer device of the invention to a lighting system is only an example. The power transfer device of the invention can be used not only for inductive coupled ballasts, but also for all non-contact charging devices.

The electronic toothbrush is another example for the application of the invention. In this application, the toothbrush charger may include the primary coil that further includes a first primary coil and a second primary coil, and the toothbrush handset may include a secondary coil, wherein the secondary coil is positioned between the first primary coil and the second primary coil, the first and the second primary coil being configured to render the directions of the magnet fields they induce across the secondary coil consistent. With such a structure, the power can be transferred from the primary coil to the secondary coil. Preferably, the first and the second primary coil and the secondary coil are rounded and arranged concentrically.

In the above examples the power is transferred from the primary coil to the secondary coil. Apparently, based on the electromagnetic interaction theory, the power can also be transferred from the secondary coil to the primary coil. In addition, the shape of the primary and secondary coils are mentioned above as annular or concentrically arranged. It is clear that in the other scenarios, the shape of the coils can be different as long as the power can be transferred effectively between primary coil and the secondary coil.

It should be noted that the above-mentioned embodiments illustrate rather than limit the invention, and that those skilled in the art will be able to design many alternative embodiments without departing from the scope of the appended claims. In the claims, use of the verb “comprise” and its conjugations does not exclude the presence of elements or steps other than those stated in a claim. Use of the indefinite article “a” or “an” preceding an element does not exclude the presence of a plurality of such elements. The mere fact that certain measures are recited in mutually different dependent claims does not indicate that a combination of these measures cannot be used to advantage.

1. A power transfer device, comprising:
a primary coil (201,202) for transferring a power, including a first primary coil (201) and a second primary coil (202);
a secondary coil (203) for transferring the power with the primary coil via electromagnetic interaction;
wherein the secondary coil (203) is positioned between the first primary coil (201) and the second primary coil (202), the first (201) and the second primary coil (202) being configured to render the directions of the magnet fields they induce across the secondary coil (203) consistent.

2. The power transfer device according to claim 1, wherein the first (201) and the second primary coil (202) and the secondary coil (203) are arranged concentrically.

3. The power transfer device according to claim 2, wherein the first (201) and the second primary coil (202) and the secondary coil (203) are annular.

4. The power transfer device according to claim 1, wherein the number of coil layers in the first (201) and the second primary coil (202) is no more than six.

5. The power transfer device according to claim 3, wherein the number of coil layers in the first (201) and the second primary coil (202) is three.

5. A device for transferring a power, comprising a first primary coil (201) and a second primary coil (202), said device being configured to transferring a power with a secondary coil (203), said secondary coil (203) being positioned in between the first (201) and the second coil (202), said first (201) and second primary coil (202) being configured to render the directions of the magnet fields they induce across the secondary coil (203) consistent.

6. A device according to claim 5, wherein the first (201) and the second primary coil (202) and the secondary coil (203) are annular and arranged concentrically.

7. A device for transferring a power, said device comprising a secondary coil (203), said secondary coil (203) being configured to transfer the power with a first primary coil (201) and a second primary coil (202), said secondary coil (203) being positioned in between the first (201) and the second primary coil (202), said first (201) and second primary coil (202) being configured to render the directions of the magnet fields they induce across the secondary coil (203) consistent.

8. A device according to claim 7, wherein the first (201) and the second primary coil (202) and the secondary coil (203) are annular and arranged concentrically.
